(19) United States
(12) Patent Application Publication
(10) Pub. No.: US 2004/0018635 A1
(43) Pub. Date: Jan. 29, 2004

(54) Fabricating arrays with drop velocity control

(76) Inventors: Bill J. Peck, Mountain View, CA (US); William G. Chesk, San Jose, CA (US); Eric M. Leproust, Campbell, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/206,446

(22) Filed: Jul. 26, 2002

(51) Int. Cl. G01N 35/00; G01N 1/10

(52) U.S. Cl. 436/180; 436/174; 436/43; 436/46; 422/63; 422/67; 422/100

(57) ABSTRACT

A method for fabricating a chemical array with multiple features. The method may include ejecting drops from an ejection head spaced from a substrate surface and during movement relative to the substrate surface, onto the substrate surface while varying an ejection velocity of the drops according to a predetermined pattern. An apparatus and computer program product which can execute such the foregoing method are also provided.

### FIELD OF THE INVENTION

This invention relates to arrays, such as polynucleotide or other biopolymer arrays (for example, DNA arrays), which are useful in diagnostic, screening, gene expression analysis, and other applications.

### BACKGROUND OF THE INVENTION

Polynucleotide arrays (such as DNA or RNA arrays), are known and are used, for example, as diagnostic or screening tools. Such arrays include regions of usually different sequence polynucleotides arranged in a predetermined configuration on a substrate. These regions (sometimes referenced as “features”) are positioned at respective locations (“addresses”) on the substrate. The arrays, when exposed to a sample, will exhibit an observed binding pattern. This binding pattern can be detected upon interrogating the array. For example all polynucleotide targets (for example, DNA) in the sample can be labeled with a suitable label (such as a fluorescent compound), and the fluorescence pattern on the array accurately observed following exposure to the sample. Assuming that the different sequence polynucleotides were correctly deposited in accordance with the predetermined configuration, then the observed binding pattern will be indicative of the presence and/or concentration of one or more polynucleotide components of the sample. Biopolymer arrays can be fabricated by depositing previously obtained biopolymers (such as from synthesis or natural sources) onto a substrate, or by in situ synthesis methods. Methods of depositing obtained biopolymers include depositing drops onto a substrate from dispensers such as pin or capillaries (such as described in U.S. Pat. No. 5,807,522) or such as pulse jets (such as a piezoelectric inkjet head, as described in PCT publications WO 95/25116 and WO 98/41531, and elsewhere). The substrate is coated with a suitable linking layer prior to deposition, such as with polylysine or other suitable coatings as described, for example, in U.S. Pat. No. 6,077,674 and the references cited therein.

For in situ fabrication methods, multiple different reagent droplets are deposited from drop dispensers at a given target location in order to form the final feature (hence a probe of the feature is synthesized on the array substrate). The in situ fabrication methods include those described in U.S. Pat. No. 5,449,754 for synthesizing peptide arrays, and described in WO 98/41531 and the references cited therein for polynucleotides. The in situ method for fabricating a polynucleotide array typically follows, at each of the multiple different addresses at which features are to be formed, the same conventional iterative sequence used in forming polynucleotides from nucleoside reagents on a support by means of known chemistry. This iterative sequence is as follows: (a) coupling a selected nucleoside through a phosphite linkage to a functionalized support in the first iteration, or a nucleoside bound to the substrate (i.e. the nucleoside-modified substrate) in subsequent iterations; (b) optionally, but preferably, blocking unreacted hydroxyl groups on the substrate bound nucleoside; (c) oxidizing the phosphite linkage of step (a) to form a phosphate linkage; and (d) removing the protecting group (“deprotection”) from the now substrate bound nucleoside coupled in step (a), to generate a reactive site for the next cycle of these steps. The functionalized support (in the first cycle) or deprotected coupled nucleoside (in subsequent cycles) provides a substrate bound moiety with a linking group for forming the phosphite linkage with a next nucleoside to be coupled in step (a). Final deprotection of nucleoside bases can be accomplished using alkaline conditions such as ammonium hydroxide, in a known manner. As can be seen, in situ fabrication involves multiple cycles, whereas the deposition of previously obtained biopolymers is generally one cycle (that is, only one occurrence of probes occurs at each feature).

The foregoing chemistry of the synthesis of polynucleotides is described in detail, for example, in Caruthers, Science 230: 281-285, 1985; Itakura et al., Ann. Rev. Biochem. 53: 323-356; Hunkapillar et al., Nature 310: 105-110, 1984; and in “Synthesis of Oligonucleotide Derivatives in Design and Targeted Reaction of Oligonucleotide Derivatives”, CRC Press, Boca Raton, Fla., pages 100 et seq., U.S. Pat. No. 4,458,066, US 4,500,707, US 5,153,319, US 5,869,643, EP 0294196, and elsewhere. Suitable linking layers on the substrate include those as described in U.S. Pat. Nos. 6,235,488 and 6,258,454 and the references cited therein.

Further details of fabricating biopolymer arrays by depositing either previously obtained biopolymers or by the in situ method are disclosed in U.S. Pat. No. 6,242,266, US 6,232,072, US 6,180,351, and US 6,171,797.

In array fabrication, the quantities of polynucleotide available, whether by deposition of previously obtained polynucleotides or by in situ synthesis, are usually very small and expensive. Additionally, sample quantities available for testing are usually also very small and it is therefore desirable to simultaneously test the same sample against a large number of different probes on an array. These conditions require use of arrays with large numbers of very small, closely spaced features. It is important in such arrays that features actually be present, that they are put down accurately in the desired target pattern, are of the correct size, and that the nucleic acid or other chemical moiety is uniformly coated within the feature. Failure to meet such quality requirements can have serious consequences to diagnostic, screening, gene expression analysis or other purposes for which the array is being used. However, for economical mass production of arrays with many features it is desirable that they can be fabricated in a short time while maintaining quality.

The present invention recognizes that in mass producing arrays to meet the foregoing requirements by ejecting drops from a drop ejection unit, such as a pulse jet, control over placement of the ejected drops on the substrate surface is important. For example, control over the placement of each drop in a series of drops sequentially deposited onto a feature location is important. Also, the present invention realizes that while drop placement can be better controlled by decreasing the speed of movement of the ejection unit relative to the substrate during drop ejection, this will tend to decrease fabrication output.

The present invention recognizes that it would be desirable then, to provide a means to control placement of ejected drops during chemical array fabrication without the need to decrease ejection unit speed relative to the substrate.

### SUMMARY OF THE INVENTION

The present invention then, provides in one aspect a method for fabricating a chemical array with multiple features. The method includes ejecting drops from an ejection head spaced from a substrate surface and during movement relative to the substrate surface, onto the substrate surface while varying an ejection velocity of the drops according to a predetermined pattern. The array may be a biopolymer array (for example a polynucleotide array), in which case at least some of the ejected drops comprise the biopolymers or their precursor units (for example, monomer units of the biopolymers).

In another aspect the a series of drops is ejected for each of multiple features from the deposition head spaced from a substrate surface and during movement in a same pass relative to the substrate surface, onto the substrate surface while varying an ejection velocity of the drops within each series. This is done such that drops within each series coalesce on the substrate surface.

In methods of the present invention where a series of drops are present as described, the drops in a series are of a same composition (each series drop including, for example, a polynucleotide or other polymer, a precursor unit, or some other component such as an activator to cause linking of precursor units). The series for each of the multiple features may be-ejected from a same deposition unit for that feature. The ejection velocity of at least some later ejected drops may be increased over that of earlier ejected drops. For example, one later ejected drop in a series may be increased over that of an earlier ejected drop in the same series. In a particular embodiment, the ejection velocity of later ejected drops may be each increased over that of a next preceding ejected drop in the same series.

Coalesced drops of a series described above, may have a minor to major axis ratio—(that is, an “aspect ratio”)—closer to unity (that is closer to 1) than a coalesced drop that is created under the same conditions but without varying the velocity within the series of ejected drops (for example, instead of a varying the velocity for drops of the series, holding the velocity for all drops of a series constant at the maximum, minimum, or average velocity of drops of the varying velocity series).

The present invention also provides a computer program product. The computer program product includes a computer readable medium which when loaded into a programmable computer executes a method described herein.

The present invention further provides an apparatus. The apparatus includes a substrate station to retain a substrate thereon. An ejection head is facing and spaced from a retained substrate. A transport system moves one of the head and retained substrate relative to the other. A control unit controls the ejection head and transport system so as to execute a method of the present invention. For example, the control unit ejects drops from the ejection head while the head is spaced from a retained substrate surface and during movement relative to the substrate surface, onto the substrate surface while varying an ejection velocity of the drops according to a predetermined pattern.

The various aspects or embodiments of the present invention can provide any one or more of the following and/or other useful benefits. For example, placement of ejected drops can be controlled during chemical array fabrication without the need to decrease ejection unit speed relative to the substrate. In one embodiment this placement can be controlled such that a series of drops coalesce into a more round drop than might otherwise be obtained.

### BRIEF DESCRIPTION OF THE DRAWINGS

Embodiments of the invention will now be described with reference to the drawings, in which:

FIG. 1 illustrates a substrate carrying multiple arrays, such as may be fabricated by methods of the present invention;

FIG. 2 is an enlarged view of a portion of FIG. 1 showing ideal spots or features;

FIG. 3 is an enlarged illustration of a portion of the substrate in FIG. 2;

FIG. 4 is a plot illustrating how ejected drop velocity control may be used to obtain focusing of the ejected drops to a desired position on an array substrate;

FIGS. 5-9 are actual images showing a series of two drops ejected from each of multiple ejection units to illustrate the principles of FIG. 4;

FIG. 10 is a plot of position versus time for the series of drops in FIGS. 5-9; and

FIG. 11 shows an apparatus of the present invention for executing a method of the present invention.

Unless otherwise indicated, drawings are not to scale. To facilitate understanding, the same reference numerals have been used, where practical, to designate elements that are common to the figures.

### DETAILED DESCRIPTION OF EMBODIMENTS OF THE INVENTION

In the present application, unless a contrary intention appears, the following terms refer to the indicated characteristics. A “biopolymer” is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (for example, a single amino acid or nucleotide with two linking groups one or both of which may have removable protecting groups). A “peptide” is used to refer to an amino acid multimer of any length (for example, more than 1, 10 to 100, or more amino acid units). A biomonomer fluid or biopolymer fluid refers to a liquid containing either a biomonomer or biopolymer, respectively (typically in solution).

A “pulse jet” is a device that can dispense drops in the formation of an array. Pulse jets operate by delivering a pulse of pressure (such as by a piezoelectric or thermoelectric element) to liquid adjacent an outlet or orifice such that a drop will be dispensed therefrom. When the arrangement, selection, and movement of “dispensers” is referenced herein, it will be understood that this refers to the point from which drops are dispensed from the dispensers (such as the outlet orifices of pulse jets). A “drop” in reference to the dispensed liquid does not imply any particular shape, for example a “drop” dispensed by a pulse jet only refers to the volume dispensed on a single activation. A drop that has contacted a substrate is often referred to as a “deposited drop” or “sessile drop” or the like, although sometimes it will be simply referenced as a drop when it is understood that it was previously deposited. Detecting a drop “at” a location, includes the drop being detected while it is traveling between a dispenser and that location, or after it has contacted that location (and hence may no longer retain its original shape) such as capturing an image of a drop on the substrate after it has assumed an approximately circular shape of a deposited drop.

An “array”, unless a contrary intention appears, includes any one, two or three-dimensional arrangement of addressable regions bearing a particular chemical moiety to moieties (for example, biopolymers such as polynucleotide sequences) associated with that region. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probes” may be the one that is evaluated by the other (thus, either one could be an unknown mixture of polynucleotides to be evaluated by binding with the other). An “array layout” refers collectively to one or more characteristics of the features, such as feature positioning, one or more feature dimensions, and some indication of a moiety at a given location. “Hybridizing” and “binding”, with respect to polynucleotides, are used interchangeably.

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

It will also be appreciated that throughout the present application, that words such as “top”, “upper”, and “lower” are used in a relative sense only. “Fluid” is used herein to reference a liquid. Reference to a singular item, includes the possibility that there are plural of the same items present. Furthermore, when one thing is “moved”, “moving”, “re-positioned”, “scanned”, or the like, with respect to another, this implies relative motion only such that either thing or both might actually be moved in relation to the other. For example, when dispensers are “moved” relative to a substrate, either one of the dispensers or substrate may actually be put into motion by the transport system while the other is held still, or both may be put into motion. All patents and other cited references herein, are incorporated into this application by reference except insofar as any may conflict with the present application (in which case the present application prevails).

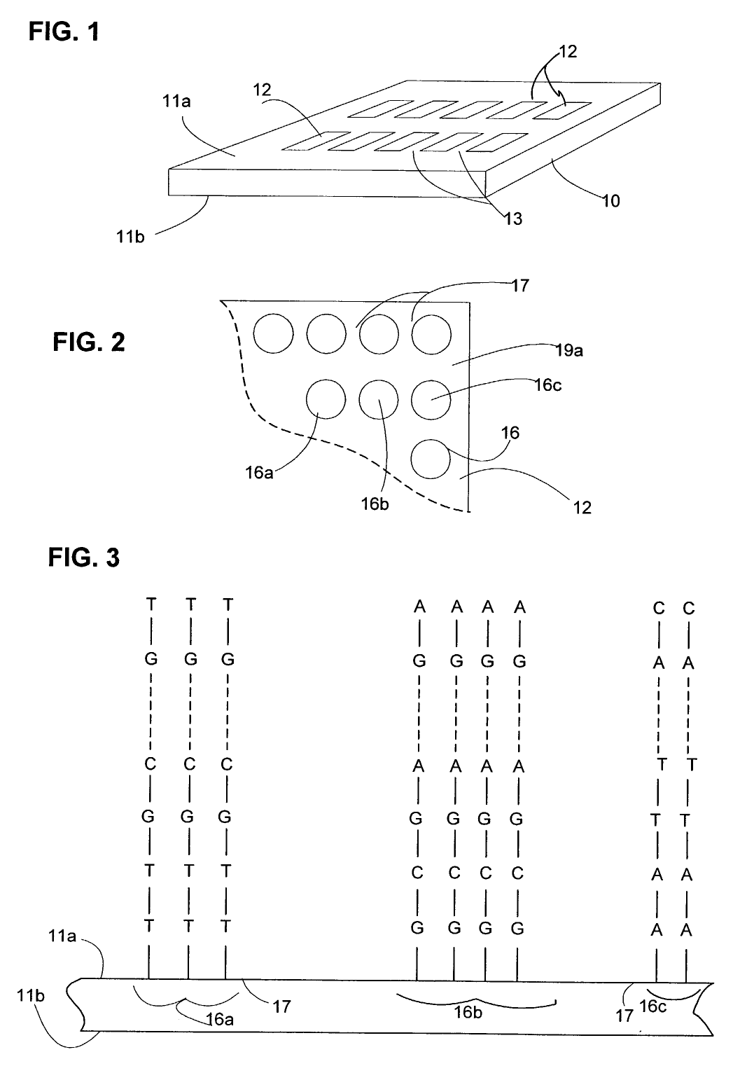

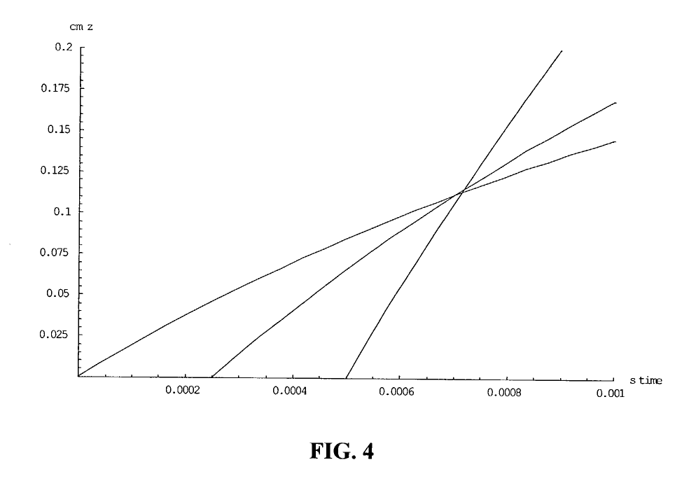

Referring first to FIGS. 1-3, typically methods and apparatus of the present invention produce a contiguous planar substrate 10 carrying one or more arrays 12 disposed across a front surface 11a of substrate 10 and separated by inter-array areas 13. A back side 11b of substrate 10 does not carry any arrays 12. The arrays on substrate 10 can be designed for testing against any type of sample, whether a trial sample, reference sample, a combination of them, or a known mixture of polynucleotides (in which latter case the arrays may be composed of features carrying unknown sequences to be evaluated). While ten arrays 12 are shown in FIG. 1 and the different embodiments described below may use substrates with particular numbers of arrays, it will be understood that substrate 10 and the embodiments to be used with it, may use any number of desired arrays 12. Similarly, substrate 10 may be of any shape, and any apparatus used with it adapted accordingly. Depending upon intended use, any or all of arrays 12 may be the same or different from one another and each will contain multiple spots or features 16 of biopolymers in the form of polynucleotides. A typical array may contain from more than ten, more than one hundred, more than one thousand or ten thousand features, or even more than from one hundred thousand features. All of the features 16 may be different, or some could be the same (for example, when any repeats of each feature composition are excluded the remaining features may account for at least 5%, 10%, 20%, or 50% of the total number of features). In the case where arrays 12 are formed by the conventional in situ or deposition of previously obtained moieties, as described above, by depositing for each feature a droplet of reagent in each cycle such as by using a pulse jet such as an inkjet type head, interfeature areas 17 will typically be present which do not carry any polynucleotide. It will be appreciated though, that the interfeature areas 17, when present, could be of various sizes and configurations. Each feature carries a predetermined polynucleotide (which includes the possibility of mixtures of polynucleotides). As per usual, A, C, G, T represent the usual nucleotides. It will be understood that there may be a linker molecule (not shown) of any known types between the front surface 11a and the first nucleotide.

Features 16 can have widths (that is, diameter, for a round spot) in the range from a minimum of about 10 μm to a maximum of about 1.0 cm. In embodiments where very small spot sizes or feature sizes are desired, material can be deposited according to the invention in small spots whose width is in the range about 1.0 μm to 1.0 mm, usually about 5.0 μm to 500 μm, and more usually about 10 μm to 200 μm. Spot sizes can be adjusted as desired, by using one or a desired number of pulses from a pulse jet to provide the desired final spot size. Features that are not round may have areas equivalent to the area ranges of round features 16 resulting from the foregoing diameter ranges. The probes of features 16 are typically linked to substrate 10 through a suitable linker, not shown.

Each array 12 may cover an area of less than 100 cm², or even less than 50, 10 or 1 cm². In many embodiments, substrate 10 will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. However, larger substrates can be used, particularly when such are cut after fabrication into smaller size substrates carrying a smaller total number of arrays 12.

An array 12 can be fabricated by ejecting drops from an ejection head (carrying one or more ejections units) onto the substrate surface 11a, during movement of the head relative to the substrate 10 (such as by scanning in a raster fashion). It is often necessary to have several drops of a series land on the same location of a feature 16 to provide sufficient reagent, such as may be required to perform a successful synthesis using the in situ method described above. However, drops ejected with the same ejection velocity from a same ejection unit will be displaced from one another along a path of travel of the head relative to the substrate 10. If the drops exit the ejection unit with the same velocity, the displacement is determined by the drop firing repetition rate of the ejection unit and the head speed relative to the substrate. Drops in a series for a feature, which are displaced too far from one another may still coalesce but will increase an aspect ration of the resulting coalesced drop and resulting feature. The aspect ratio is the ratio of minor axis (minimum linear dimension) to major axis (maximum linear dimension) of the surface formed by the intersection of the coalesced drop on the substrate (the coalesced drop being taken herein as the resulting sessile drop which is stationary on the surface). The sessile drop aspect ratio can be measured during the array manufacturing process to ensure this ratio is within a desired specification.

The geometric qualities of the sessile drop will also depend on the material properties of the drop: surface tension, viscosity, impact velocity as well as the properties of the substrate upon which it impacts. Important factors here are the surface energy of the substrate, the contact angle of the drop on that surface and the viscosity of the drop fluid. These properties will act to assist or retard the coalescence of the individual droplets into a single sessile droplet. For a given set of material properties the head scanning speed is limited by the repetition rate of the ejection unit and the distance between droplet impacts required for achieving the qualities described above. However, the ejection unit cannot be forced to fire too rapidly in an attempt to have drops of a series contact the substrate surface at the same location, otherwise the period between droplet ejections will be too low and there will be insufficient time for transient motion in the head to be damped out. This often causes head failures and reduced jetting reliability.

A method of the present invention to reduce the spacing of the impact sites of drops is to eject individual droplets with individually varying velocities for a given firing frequency. The first drop out will have a lower speed than the next drop out. In this way the second drop out will tend to catch up with the first drop effectively reducing the spacing between the drop impact sites. This technique can also have the advantage that the last drop out is the most energetic and requires the greatest time for transient motions to settle out in the printhead. In most applications it is likely that the time between ejection of the last drop out of one series and the first drop out of a next following series (which will be used to create the next feature) will be much greater than the period between waveforms for the drops within a series for a same feature. This method can be understood with reference to the further discussion on Kinematics and Dynamics below.

Kinematics

First, it will be assumed that a drop is produced with an initial speed Uⱼₙ and that the drop is unaffected by drag during its flight through the ambient atmosphere. With these assumptions the problem becomes one of simple kinematics. It will also be assumed that the substrate is moving relative to a head-fixed reference frame. The scan speed of the substrate is Uₛ. For the case of two droplets Uⱼ₁ will be used to denote the vertical speed of drop 1 and Uⱼ₂ to denote the vertical speed of drop 2. At time tₒ it is assumed the substrate is at xₒ. The first drop will land on x₁ at t₁ and the second on x₂ at t₂. The distance between the substrate and the head is given by z. The time between drop ejections is given by τⱼ. At this point there are two independent systems of equations. The two systems can be related to obtain specified values of δₓ, that is, the droplet impact spacing distance. Hence the two equations:

t₁=z/Uⱼ₁ (Eq. 1)

t₂=z/Uⱼ₂+τⱼ (Eq. 2)

Drop placement is given by:

x₁=Uₛ×t₁, x₂=Uₛ×t₂ (Eq. 3)

It is also possible to write an equation for the drop impact spacing:

δₓ=x₁−x₂ (Eq. 4)

so that there is now a set of five equations and ten unknowns: (x₁,x₂,t₁,t₂,δₓ,Uₛ,Uⱼ₁,Uⱼ₂,z,τⱼ). By specifying five of the variables the system of equations can be solved.

As an example, to determine the displacement between two drops first specify (Uₛ,Uⱼ₁,Uⱼ₂,z,τⱼ) and solve for (x₁,x₂,t₁,t₂,δₓ). The solution gives a droplet impact spacing of:

$$\vert {δ}_{x} \vert = \vert {U}_{s} z [ \frac{1}{{U}_{j1}} - ( \frac{τ}{z} + \frac{1}{{U}_{j2}} ) ] \vert \qquad ( Eq . 5 )$$

For the current process parameters of Us=10 cm/s, Uⱼ₁=Uⱼ₂=6-8 m/s, Tau=167 μs and z=750 (um), this droplet impact spacing is about 17 μm. It is noted however, that with Uⱼ₁=Uⱼ₂ Eq 5 reduces to the simple form δₓ=Uₛτ. With focusing using velocity control, this model predicts the drop firing period can be increased to 250 μs using waveforms that produce initial velocities of 3.7, 5.4 and 8 m/s while maintaining the same droplet impact spacing.

Dynamics

In the previous section any subtleties introduced into the problem from external forces such as viscous and pressure drag were neglected. For inkjet printing the jetting velocities are typically in the 100 to 1000 cm/s range with droplets ranging from 10 to 100 μm. Considering the droplet to be a sphere of diameter D travelling through air with a kinematic viscosity v of 15 cm\hat{ }2/s yields Reynolds numbers in the range of 0.01 to near 1. The Reynolds number is given by Eq. 6:

$$Re = \frac{U \times D}{v} . \qquad ( Eq . 6 )$$

Thus, the most important contribution to slowing the drop will come from viscous forces caused by friction with the ambient atmosphere. This drag effect can be estimated using flow over a solid sphere as a model.

Since the largest Reynolds number encountered in this problem are very low, <1 the following Stokes approximation is used:

F_{drag}=6×π×μ×r×U (Eq. 7)

Now using a force balance on a sphere of mass m gives the equation:

$$m \frac{ⅆ U}{ⅆ t} = - 6 \times π \times μ \times r \times U \qquad ( Eq . 8 )$$

The left hand side of Eq 8 represents the change in momentum while the light hand side is the viscous drag. Note that the small effects due to gravity have been ignored. Thus, the analysis will not be valid after the drop slows to a point close to its settling speed, which is well below 1 m/s in the present case. The mass can be replaced by the known density of the liquid ρ₁ and volume of an assumed spherical droplet so that:

$$\frac{4}{3} π {r}^{3} {ρ}_{l} \frac{ⅆ U}{ⅆ t} = - 6 \times π \times μ \times r \times U \qquad ( Eq . 9 )$$

The solution to this equation is a first order exponential decay:

$$U ( t ) = {U}_{o} exp ( - \frac{t}{{τ}_{d}} ) \qquad ( Eq . 10 )$$

Where

$${τ}_{d} = \frac{2 {r}^{2}}{9 υ {ρ}_{r}}$$

and ρᵣ is the ratio of the liquid density to air density Integrating once more gives z(t).

$$z ( t ) = {U}_{o} {τ}_{d} [ 1 - exp ( - \frac{t}{{τ}_{d}} ) ] \qquad ( Eq . 11 )$$

A plot of this equation of z (in mm) versus time (in seconds) for drops fired with an initial speed of 2.0, 3.4 and 8 m/s at intervals of 250 microseconds, is shown in FIG. 4 below and illustrates the focusing effect in the presence of viscous drag. Thus, even with the addition of a drag force a focusing effect can still be achieved and slightly enhances it.

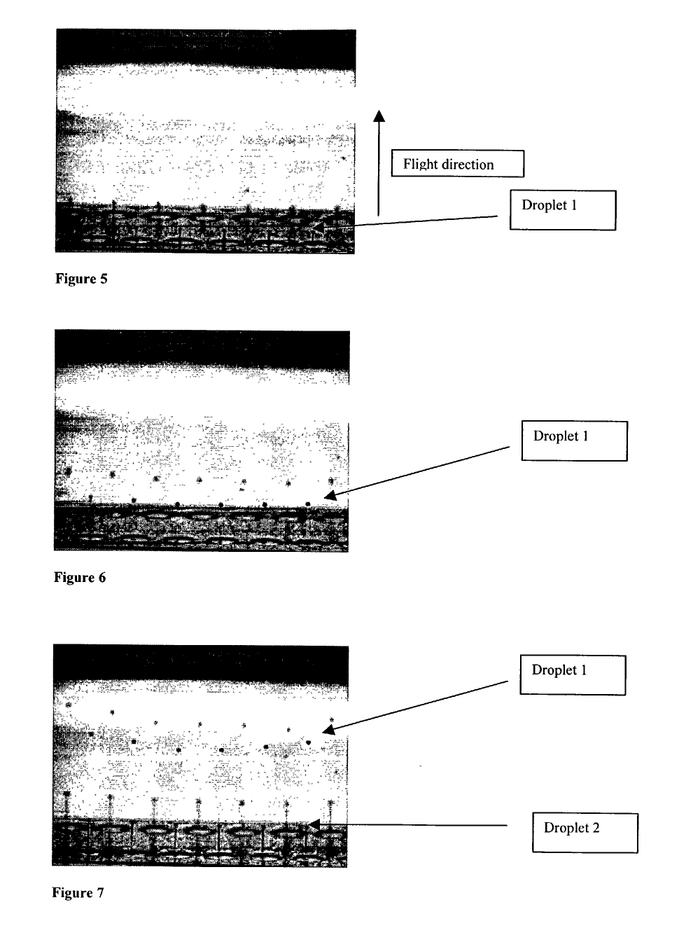

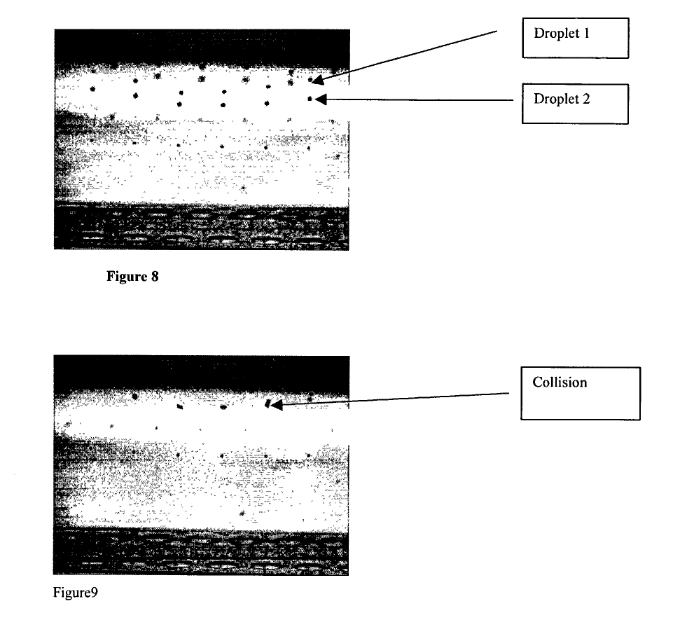

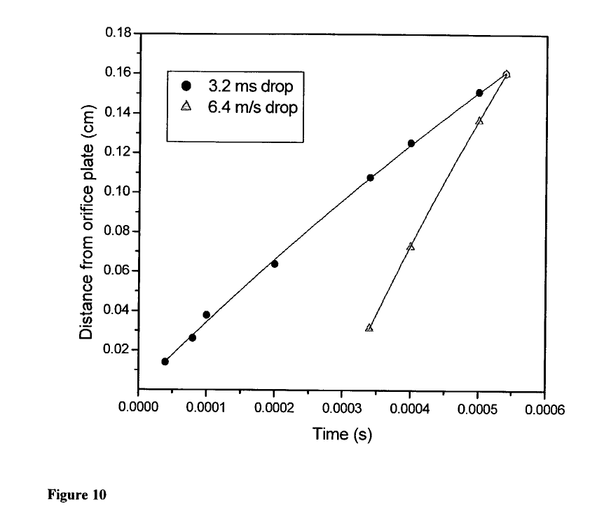

Turning now to FIGS. 5-9, these illustrate the application of the above drop series focusing to an actual ejection of multiple drops in a same pass from an ejector unit. By a “same pass” in this context is meant while the ejector unit is moving in a same direction over a same location (another pass occurring when the ejector unit returns to pass over and eject drops onto the same location again). Such images can be obtained by using a high speed strobe flash in conjunction with a camera of sufficiently high resolution. In particular, the images of FIGS. 5-9 show an actual ejection of a two-drop series from each of multiple ejector unit orifices in a head, where the first drop leaves with a velocity of 3.2 m/s and the second drop leaves with a velocity of 6.4 m/s. The head was a EPSON piezoelectric type head, and a waveform was applied to each head piezoelectric crystal having two pulses of amplitude 17 followed by 25 volts, and delay between the two pulses of 250 μs. The time delay is selected for the particular head as being a short as delay as possible as is expected to be usable with the particular head while still allowing transient motion in the head to be damped out. This can be obtained as a recommended figure from a head manufacturer or can be determined experimentally using known means. Such time delays are typically between 50 μs to 500 μs (or even between 20 μs to 1 ms. As can be seen from FIG. 9 the drops of a two-drop series do coalesce at 1600 microns above the orifice (in the orientation as viewed in FIG. 9). For reference the orifices of the ejector units are 424 microns apart. The images are inverted so the drops appear to be traveling upward as viewed in the drawings. FIG. 10 is a plot of the leading edge position (in cm) of the droplets of two different velocities shown in FIGS. 5-9, versus time (in seconds). Note that the actual result from the foregoing experiment is reasonably consistent with the theoretical behavior predicted in Eq 11 and plotted in FIG. 4.

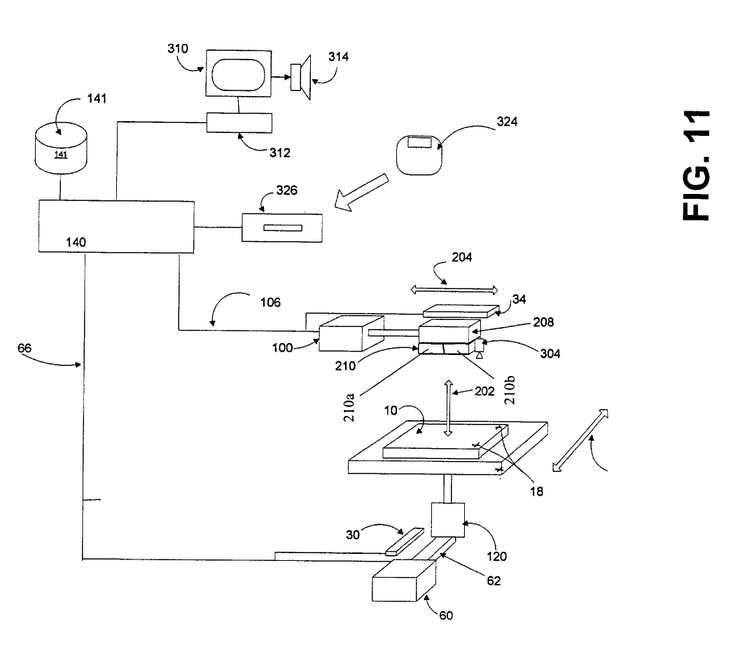

Referring to FIG. 11, an apparatus of the present invention and its operation in accordance with a method of the present invention, will now be discussed. For the purposes of the discussions below, it will be assumed (unless the contrary is indicated) that the array being formed in any case is a polynucleotide array formed by the in situ fabrication method for an array. However, the apparatus and methods can be applied to array fabrication by deposition of previously obtained polynucleotides using pulse jet deposition units. Further, the apparatus and methods can be applied to arrays of other polymers or chemical moieties generally, whether formed by multiple cycle in situ methods or deposition of previously obtained moieties.

Referring to FIG. 11 an apparatus of the present invention includes a substrate station 20 on which a substrate 10 can be retained. Pins or similar means (not shown) can be provided on substrate station 20 by which to approximately align substrate 10 to a nominal position thereon. Substrate 10 may be retained on substrate station 20 simply by weight. However, more secure retention is provided by substrate station 20 including a vacuum chuck connected to a suitable vacuum source (not shown) to retain a substrate 10 without exerting too much pressure thereon, since substrate 10 is often made of glass or silica.

A movable ejection head system 210 (with two heads 210a, 210b) is retained by a head retainer 208. Head system 210 can be positioned at any position facing a retained substrate 10, by means of a transport system. The transport system includes a carriage 62 connected to a first transporter 60 controlled by processor 140 through line 66, and a second transporter 100 controlled by processor 140 through line 106. Transporter 60 and carriage 62 are used to execute one axis positioning of station 20 (and hence mounted substrate 10) facing the dispensing head system 210, by moving it in the direction of nominal axis 63, while transporter 100 is used to provide adjustment of the position of head retainer 208 in a direction of nominal axis 204. In this manner, head system 210 can be scanned line by line, by scanning along a line over substrate 10 in the direction of axis 204 using transporter 100 while substrate 10 is stationary, while line by line movement of substrate 10 in a direction of axis 63 is provided by transporter 60 while head system 210 is stationary. Head system 210 may also optionally be moved in a vertical direction 202, by another suitable transporter (not shown). However, it will be appreciated that other scanning configurations could be used. Also, it will be appreciated that both transporters 60 and 100, or either one of them, with suitable construction, could be used to perform the foregoing scanning of head system 210 with respect to substrate 10. Thus, when the present application refers to “positioning”, “moving”, or “displacing” or the like, one element (such as head system 210) in relation to another element (such as one of the stations 20 or substrate 10) it will be understood that any required moving can be accomplished by moving either element or a combination of both of them. An encoder 30 communicates with processor 140 to provide data on the exact location of substrate station 20 (and hence substrate 10 if positioned correctly on substrate station 20), while encoder 34 provides data on the exact location of holder 208 (and hence head system 210 if positioned correctly on holder 208). Any suitable encoder, such as an optical encoder, may be used which provides data on linear position. Angular positioning of substrate station 20 is provided by a transporter 120, which can rotate substrate station 20 about axis 202 under control of processor 140. Typically, substrate station 20 (and hence a mounted substrate) is rotated by transporter 120 under control of processor 140 in response to an observed angular position of substrate 10 as determined by processor 140 through viewing one or more fiducial marks on a retained substrate 10 (particularly fiducial marks 18) with a camera (such as camera 304). This rotation will continue until substrate 10 has reached a predetermined angular relationship with respect to dispensing head system 210. In the case of a square or rectangular substrate, the mounted substrate 10 will typically be rotated to align one edge (length or width) with the scan direction of head system 210 along axis 204.

Head system 210 may contain one or more (for example, two or three) heads mounted on the same head retainer 208. Each such head may be the same in construction as a head type commonly used in an ink jet type of printer. Each ejector is in the form of a piezoelectric crystal operating under control of processor 140 (although resistors for thermally activated ejectors could be used instead). Each orifice with its associated ejector and portion of the chamber, defines a corresponding pulse jet with the orifice acting as a nozzle. It will be appreciated that head system 210 could have any desired number of pulse jets (for example, at least fifty or at least one hundred pulse jets). In this manner, application of a single electric pulse to an ejector causes a droplet to be dispensed from a corresponding orifice. Elements of each head can be adapted from commercially available piezoelectric inkjet print heads. One type of head and other suitable dispensing head designs are described in more detail in U.S. patent application entitled “A MULTIPLE RESERVOIR INK JET DEVICE FOR THE FABRICATION OF BIOMOLECULAR ARRAYS” Ser. No. 09/150,507 filed Sep. 9, 1998. Piezoelectric pulse jets may be used in heads otherwise of the foregoing construction.

As is well known in the ink jet print art, the amount of fluid that is expelled in a single activation event of a pulse jet, can be controlled by changing one or more of a number of parameters, including the orifice diameter, the orifice length (thickness of the orifice member at the orifice), the size of the deposition chamber, and the size of the piezoelectric or heating element, among others. The amount of fluid that is expelled during a single activation event is generally in the range about 0.1 to 1000 pL, usually about 0.5 to 500 pL and more usually about 1.0 to 250 pL. A typical velocity at which the fluid is expelled from the chamber is more than about 1 m/s, or may be more than about 10 m/s, and may be as great as about 20 m/s or greater.

The apparatus further includes a sensor in the form of a camera 304, to monitor dispensers for errors (such as failure to dispense droplets) by monitoring for drops dispensed onto substrate 10 when required of a dispenser. Camera 304 can also image the structures on surface 11a. Camera 304 communicates with processor 140, and should have a resolution that provides a pixel size of about 1 to 100 micrometers and more typically about 4 to 20 micrometers or even 1 to 5 micrometers. Any suitable analog or digital image capture device (including a line by line scanner) can be used for such camera, although if an analog camera is used processor 140 should include a suitable analog/digital converter. A detailed arrangement and use of such a camera to monitor for dispenser errors, is described in U.S. Pat. No. 6,232,072. Particular observations techniques are described, for example, in co-pending U.S. patent application Ser. No. 09/302,898 filed Apr. 30, 1999 by Caren et al., assigned to the same assignee as the present application, incorporated herein by reference. Monitoring can occur during formation of an array and the information used during fabrication of the remainder of that array or another array, or test-print patterns can be run before array fabrication. A display 310, speaker 314, and operator input device 312, are further provided. Operator input device 312 may, for example, be a keyboard, mouse, or the like. Processor 140 has access to a memory 141, and controls print head system 210 (specifically, the activation of the ejectors therein), operation of the transport system, operation of each jet in print head system 210, capture and evaluation of images from the camera 304, and operation display 310 and speaker 314. Memory 141 may be any suitable device in which processor 140 can store and retrieve data, such as magnetic, optical, or solid state storage devices (including magnetic or optical disks or tape or RAM, or any other suitable device, either fixed or portable). Processor 140 may include a general purpose digital microprocessor suitably programmed from a computer readable medium carrying necessary program code, to execute all of the functions required of it as described below. It will be appreciated though, that when a “processor” such as processor 140 is referenced throughout this application, that such includes any hardware and/or software combination which will perform the required functions. Suitable programming can be provided remotely to processor 140, or previously saved in a computer program product such as memory 141 or some other portable or fixed computer readable storage medium using any of those devices mentioned below in connection with memory 141. For example, a magnetic or optical disk 324 may carry the programming, and can be read by disk reader 326.

Operation of the apparatus of FIG. 11 in accordance with a method of the present invention, will now be described. First, it will be assumed that memory 141 holds a target drive pattern. This target drive pattern is the instructions for driving the apparatus components as required to form the target array (which includes target locations and dimension for each spot) on substrate 10 and includes, for example, movement commands to transporters 60 and 100 as well as firing commands for each of the pulse jets in head system 210 coordinated with the movement of head system 210 and substrate 10, as well as instructions as to which polynucleotide precursor solution or activator solution is loaded in each pulse jet—that is, the “loading pattern”. Such solutions may be provided to the different pulse jets through appropriate respective conduits (not shown) communicating between the head system 210 and respective reservoirs (not shown). An appropriate arrangement of the foregoing is disclosed, for example, in U.S. Pat. No. 6,372,483. The target drive pattern is based upon the target array pattern and can have either been input from an appropriate source (such as input device 312, a portable magnetic or optical medium, or from a remote server, any of which communicate with processor 140), or may have been determined by processor 140 based upon an input target array pattern (using any of the appropriate sources previously mentioned) and the previously known nominal operating parameters of the apparatus. Further, it will be assumed that drops of different biomonomer or biopolymer containing fluids (or other fluids) have been placed at respective regions of a loading station (not shown).

Note that in the target drive pattern the waveform supplied to each piezoelectric crystal in head system 210 determines the deformation of the crystal, which in turn determines the pressure pulse imparted on the fluid in the pulse jet. The velocity of the exiting drops can be adjusted by adjusting the amplitude of each pulse in the waveform. An adjustment of waveform to obtain velocity control is generally described in U.S. Pat. No. 6,402,282 and European patent publication EP0721840A2, although in those references the amplitude is fixed for the whole waveform to obtain a constant velocity for all drops. The actual waveform required (period and amplitude) may vary for any particular head, and can be determined by varying period and amplitude for a single pulse waveform, and capturing images such as those of FIGS. 5-9 and developing a plot as in FIG. 10 for each variation of period and amplitude. From these plots and the known distance to a retained substrate 10 front surface 11a, the appropriate waveform can be determined; either by selection where a plot illustrates all drops of the series collide with one another, or by interpolation if needed. If a series of drops to be deposited at each feature location will have three or more drops, the procedure in FIGS. 5-10 can be modified so that each pulse unit ejects the required number of three or more drops.

A drive waveform of the target drive pattern can be constructed for each pulse jet by processor 140 using individual pulses of increasing amplitude that will produce droplets with increasing speed. This drive waveform can consist of one or multiple pulses, depending on the desired number of drops (such as the number of drops in a series) to be deposited on surface 11a. In general, a multi-pulse drive waveform is composed of singular pulse waveforms of varying amplitude and time delay between pulses. One method of constructing these composite drive waveforms is to use an alphabet of basic singular waveforms of specific amplitude and duration stored individually in electronic memory 141. The time delay between successive pulses is previously provided to processor 140 as part of its programming, and is specified by processor 140 at the time of composite waveform synthesis. The type and number of singular pulses and the time delay between them is encoded by processor 140 in the eject command used to fire the piezoelectric crystal of each pulse jet in head system 210. When droplets are to be ejected to an impact site (such as a series of drops for a feature location), the eject command in the programming of processor 140 causes it to access the appropriate singular pulse waveforms in memory 141 and insert the specified time delay between such singular pulses to obtain the multi-pulse waveform. This sequence of events occurs for every site ejection so that different composite waveforms may be synthesized for each impact site. This repeating waveform synthesis per impact site will occur at the printing rate of the deposition apparatus.

Operation of the following additional events are controlled by processor 140, following initial operator activation, unless a contrary indication appears.

Substrate 10 is loaded onto substrate station 20, if not previously loaded, either manually by an operator, or optionally by a suitable automated driver (not shown) controlled, for example, by processor 140. The deposition sequence is-then initiated to deposit the desired sequence of drops of nucleotide monomers (particular phosphoramidite monomers) or activator solution, onto the substrate according to the drive pattern. As already mentioned, in this sequence processor 140 will operate the apparatus according to the drive pattern, by causing the transport system to position head system 210 facing substrate station 20, and particularly the retained substrate 10, and with head system 210 at an appropriate distance from substrate 10. Processor 140 then causes the transport system to scan head system 210 across substrate 10 line by line (or in some other desired pattern), while co-coordinating activation of the ejectors in head system 210 so as to dispense droplets as described above. This may include the droplet deposition over multiple cycles as required by the in situ synthesis process. For the in situ process the substrate may be moved between cycles to a flood station for exposure of the entire surface 11a to an oxidizing agent and deprotecting agent, in a known manner.

At this point the droplet dispensing sequence is complete and the arrays have been fabricated on surface 11a. A final deprotection step may be required as is known.

Following receipt by a user of an array made by an apparatus or method of the present invention, it will typically be exposed to a sample (for example, a fluorescently labeled polynucleotide or protein containing sample) and the array then read. Reading of the array may be accomplished by illuminating the array and reading the location and intensity of the resulting fluorescence at each feature of the array. For example, a scanner may be used for this purpose which is similar to the AGILENT MICROARRAY SCANNER manufactured by Agilent Technologies, Palo Alto, Calif. Other suitable apparatus and methods are described in U.S. patent application Ser. No. 09/846,125 “Reading Multi-Featured Arrays” by Dorsel et al.; and Ser. No. 09/430,214 “Interrogating Multi-Featured Arrays” by Dorsel et al. As previously mentioned, these references are incorporated herein by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. Nos. 6,251,685, 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample, or whether or not a pattern indicates a particular condition of an organism from which the sample came). The results of the reading (processed or not) may be forwarded (such as by communication) to a remote location if desired, and received there for further use (such as further processing).

The present methods and apparatus may be used to deposit biopolymers or other chemical moieties on surfaces of any of a variety of different substrates, including both flexible and rigid substrates. Preferred materials provide physical support for the deposited material and endure the conditions of the deposition process and of any subsequent treatment or handling or processing that may be encountered in the use of the particular array. The array substrate may take any of a variety of configurations ranging from simple to complex. Thus, the substrate could have generally planar form, as for example a slide or plate configuration, such as a rectangular or square or disc.

In the present invention, any of a variety of geometries of arrays on a substrate 10 may be fabricated other than the rectilinear rows and columns of arrays 12 of FIG. 1. For example, arrays 12 can be arranged in a sequence of curvilinear rows across the substrate surface (for example, a sequence of concentric circles or semi-circles of spots), or in some other arrangement. Similarly, the pattern of features 16 may be varied from the rectilinear rows and columns of spots in FIG. 2 to include, for example, a sequence of curvilinear rows across the substrate surface (for example, a sequence of concentric circles or semi-circles of spots), or some other regular pattern. Even irregular arrangements are possible provided a user is provided with some means (for example, an accompanying description) of the location and an identifying characteristic of the features (either before or after exposure to a sample). In any such cases, the arrangement of dispensers in head system 210 may be altered accordingly. The configuration of the arrays and their features may be selected according to manufacturing, handling, and use considerations.

The substrates will typically be non-porous, and may be fabricated from any of a variety of materials. In certain embodiments, such as for example where production of binding pair arrays for use in research and related applications is desired, the materials from which the substrate may be fabricated should ideally exhibit a low level of non-specific binding during hybridization events. In many situations, it will also be preferable to employ a material that is transparent to visible and/or UV light. For flexible substrates, materials of interest include: nylon, both modified and unmodified, nitrocellulose, polypropylene, and the like, where a nylon membrane, as well as derivatives thereof, may be particularly useful in this embodiment. For rigid substrates, specific materials of interest include: glass; fused silica; plastics (for example, polytetrafluoroethylene, polypropylene, polystyrene, polycarbonate, and blends thereof, and the like); metals (for example, gold, platinum, and the like).

The substrate surface onto which the polynucleotide compositions or other moieties are deposited may be smooth or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethyleneamines, polyarylene sulfides, polysiloxanes, polyimides, polyacetates, and the like, where the polymers may be hetero- or homopolymeric, and may or may not have separate functional moieties attached thereto (for example, conjugated).

Ejection velocities of drops ejected in the fabrication of arrays may be varied during fabrication by any pattern, other than within a series as described above, depending upon application. For example, it may be desired to form a second feature which has a spacing to a preceding adjacent first feature which is less than to a subsequent adjacent third feature (preceding and subsequent being the sequence in time for which features drops are deposited). In this case, the ejection velocity of one or more drops in a series for the second feature can be increased over the ejection velocity used for one or more drops for the first and third features.

Various further modifications to the particular embodiments described above are, of course, possible. Accordingly, the present invention is not limited to the particular embodiments described in detail above. Indeed the techniques described herein can be applied to any application where discrete spots on a substrate need to be deposited. This includes flat panel displays and the like.

What is claimed is:

1. A method for fabricating a chemical array with multiple features, comprising:
ejecting drops from an ejection head spaced from a substrate surface and during movement relative to the substrate surface, onto the substrate surface while varying an ejection velocity of the drops according to a predetermined pattern.

2. A method according to claim 1 wherein the ejection velocity of at least some later ejected drops is increased over that of earlier ejected drops.

3. A method according to claim 1 wherein the chemical array is a biopolymer array and the ejected drops comprise the biopolymers or their precursor units.

4. A method according to claim 3 wherein the biopolymers are polyncucleotides.

5. A method for fabricating a chemical array with multiple features, comprising:
ejecting a series of drops for each of multiple features from an ejection head spaced from a substrate surface and during movement in a same pass relative to the substrate surface, onto the substrate surface such that drops within each series coalesce while varying an ejection velocity of the drops within each series.

6. A method according to claim 5 wherein the drops in a series are of a same composition.

7. A method according to claim 5 wherein the series for each of the multiple features is ejected from a same deposition unit for that feature and the ejection velocity of at least one later ejected drop in a series is increased over that of an earlier ejected drop in the same series.

8. A method according to claim 7 wherein the ejection velocity of later ejected drops is each increased over that of a next preceding ejected drop in the same series.

9. A method according to claim 5 wherein the coalesced drops of a series have a minor to major axis ratio closer to one that would be obtained under the same conditions but absent varying the velocity within the series.

10. A method according to claim 5 wherein the ejection velocity of at least some later ejected drops is increased over that of earlier ejected drops.

11. A method according to claim 5 wherein the chemical array is a biopolymer array and the ejected drops comprise the biopolymers or their precursor units.

12. A method according to claim 11 wherein the biopolymers are polyncucleotides.

13. A method comprising forwarding data representing a result of a reading an array fabricated by a method of claim 1.

14. A method according to claim 13 wherein the data is communicated to a remote location.

15. A method comprising receiving data representing a result of reading an array fabricated by the method of claim 1.

16. A computer program product comprising a computer readable medium which when loaded into a programmable computer executes a method of claim 1.

17. A computer program product comprising a computer readable medium which when loaded into a programmable computer executes a method of claim 5.

18. An apparatus comprising:
a) a substrate station to retain a substrate thereon;
b) an ejection head which is facing and spaced from a retained substrate;
c) a transport system to move one of the head and retained substrate relative to the other;
d) a control unit which controls the ejection head and transport system so as to eject drops from the ejection head while spaced from a retained substrate surface and during movement relative to the substrate surface, onto the substrate surface while varying an ejection velocity of the drops according to a predetermined pattern.

19. An apparatus according to claim 18 wherein the control unit controls the ejection velocity of at least some later ejected drops such that they are increased over that of earlier ejected drops.

20. An apparatus comprising:
a) a substrate station to retain a substrate thereon;
b) an ejection head which is facing and spaced from a retained substrate;
c) a transport system to move one of the head and retained substrate relative to the other;
d) a control unit which controls the ejection head and transport system so as to eject a series of drops for each of multiple features from a deposition head spaced from a retained substrate surface and during movement in a same pass relative to the substrate surface, onto the substrate surface such that drops within each series coalesce while varying an ejection velocity of the drops within each series.

21. An apparatus according to claim 20 wherein the controller controls the ejection head and transport system such that a series for each of the multiple features is ejected from a same deposition unit for that feature and the ejection velocity of at least one later ejected drop in a series is increased over that of an earlier ejected drop in the same series.

22. An apparatus according to claim 20 wherein the controller controls the ejection head and transport system such that the ejection velocity of later ejected drops is each increased over that of a next preceding ejected drop in the same series.
